(19) United States
(12) Patent Application Publication
(10) Pub. No.: US 2003/0224775 A1
(43) Pub. Date: Dec. 4, 2003

(54) Radio access communication system capable of preventing packet loss

(75) Inventors: Yukinori Suda, Tokyo (JP); Morihisa Momona, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/300,002

(22) Filed: Nov. 20, 2002

(30) Foreign Application Priority Data
Nov. 21, 2001 (JP) 355658/2001

(51) Int. Cl. H04Q 7/20

(52) U.S. Cl. 455/422.1; 455/424

(57) ABSTRACT

A radio terminal device informs a radio base station of entrance into a communication suppress mode such as a power saving mode by transmitting a state transition informing packet to the radio base station, when detecting deterioration of a communication. The packet received by the radio base station in this state is retained by the radio base station. When receiving an acknowledgment signal from the radio base station, the radio terminal device changes the setting of a receiver to a radio channel different from a radio channel used in the communication with the radio base station, and searches for other radio base stations.

### BACKGROUND OF THE INVENTION

1. Field of the Invention

The present invention relates to a radio access communication system, a radio terminal device and a radio base station for use therein, and a radio access communication method, and particularly, relates to a radio access communication system capable of preventing a packet loss between the radio terminal device and radio base station, a radio access communication method, and a program for use in the radio access communication system.

2. Description of the Related Art

In general, a radio access communication system of this kind includes a plurality of radio base stations for defining cells, and a radio terminal device such as a mobile telephone or a PDA (Personal Digital Assistants). The radio terminal device includes a cellular system and a wireless LAN system. The cellular system enables communication while moving among a plurality of cells, as in a GSM system, a PDC system or the like. The wireless LAN system is standardized under IEEE 802.11, and is for performing radio communication in an area of the base station mainly with a personal computer as the radio terminal device. In the cellular system and wireless LAN system, data or the like is transmitted/received in the form of a packet.

In any case, it is highly likely that the radio terminal device used in the radio access communication system of this kind would move among the cells or among the areas. Therefore, when the radio terminal device under the communication moves from one cell to another cell, it is necessary for the radio terminal device to switch (handover) from one radio base station under the connection to another radio base station.

Various techniques have been considered and used in association with such handover. For example, in the GSM system and PDC system, a radio channel is divided into time slots, and is synchronized between the radio base station and the radio terminal device. Therefore, the radio terminal device searches for other radio base stations using a time slot other than the allotted time slot, thereby accomplishing significantly shortened handover time. Such an example is disclosed in, for instance, Japanese Patent Publication Laid-open No. 5-73297.

On the other hand, in the wireless LAN standardized under the IEEE 802.11, the radio base station (access point) and a plurality of radio terminal devices obtain a radio channel by random access, and transmit packets asynchronously, unlike in the GSM system and PDC system. Therefore, it is necessary for the radio terminal device to receive all the packets transmitted to the radio channel and judge whether the packets are addressed to the device itself.

In the aforementioned radio access communication system for performing packet transmission asynchronously, when the radio terminal device equipped with only one receiver is used, the following problems are posed. Namely, if this radio terminal device searches for the neighboring radio base stations, a packet loss is caused. Such a packet loss has a great impact especially when data is transmitted/received.

The cause of the packet loss is as follows. It is necessary to tune the receiver to a radio frequency different from the radio frequency used at present, in order for the radio terminal device to search for the neighboring radio base stations. When the radio base station transmits a packet addressed to the radio terminal device during the tuning, the packet loss is caused.

On the other hand, in the radio access communication system for performing packet transmission asynchronously, use of a radio terminal device comprising a plurality of receivers is also proposed. In this case, in the radio terminal device, one receiver is always tuned to one radio frequency, and the other receivers are used to search for the neighboring radio base stations using different radio frequencies. However, the radio terminal device comprising a plurality of receivers causes increased costs, an obstacle to a size reduction, and increased power consumption, presenting a difficulty in an aspect of economical efficiency.

### SUMMARY OF THE INVENTION

Therefore, an object of the present invention is to provide a radio access communication system for searching for neighboring radio base stations without causing a packet loss even if a radio terminal device equipped with only one transmitter/receiver is used in the radio access communication system for performing packet transmission asynchronously.

Another object of the present invention is to provide a radio access communication method suitable for the above radio access communication system.

Still another object of the present invention is to provide a radio terminal device capable of performing handover without causing a packet loss.

Yet another object of the present invention is to provide a radio base station capable of communicating with the aforementioned radio terminal device.

The present invention is applied to a radio access communication system including a plurality of radio base stations and a radio terminal device connectable to the plurality of radio base stations.

According to a first aspect of the present invention, a radio terminal device includes a judgment unit for judging whether communication conditions have deteriorated. When connected to a first radio base station included in the plurality of radio base stations, the radio terminal device transmits a transmission suppress signal for controlling a communication with the radio terminal device to the first radio base station if the communication conditions with the first radio base station deteriorate, and the radio terminal device searches for the communication conditions with other radio base stations. When receiving the transmission suppress signal, the first radio base station temporarily retains data addressed to the radio terminal device. The radio terminal device can be connected to the other radio base station according to the result of the search.

According to a second aspect of the present invention, each of radio base stations includes a judgment unit for judging whether communication conditions have deteriorated. A first radio base station connected to a radio terminal device, among a plurality of radio base stations, controls a communication with the radio terminal device if the communication conditions with the radio terminal device deteriorate. The first radio base station also transmits a transmission suppress signal to the radio terminal device, and lets the radio terminal device search for the communication conditions with other radio base stations.

According to a third aspect of the present invention, a radio terminal device includes a judgment unit for judging whether communication conditions have deteriorated. When connected to a first radio base station included in a plurality of radio base stations, the radio terminal device transmits a transmission suppress signal for controlling a communication with the radio terminal device to the first radio base station if the communication conditions with the first radio base station deteriorate, and the radio terminal device searches for the communication conditions with other radio base stations. The radio terminal device also transmits a control information requesting signal to detect whether a radio base station exists, when searching for the communication conditions with the other radio base stations.

According to a fourth aspect of the present invention, a radio terminal device connectable with a plurality of radio base stations is provided. The radio terminal device can operate in an operation mode of either a normal mode or a communication suppress mode. The radio terminal device includes an informing unit for informing of communication conditions with a radio base station being connected to among the plurality of radio base stations, and a control unit for changing the operation mode to the communication suppress mode when detecting deterioration of the informed communication conditions. In this case, the control unit transmits a transmission suppress signal for informing the radio base station being connected to of entrance into a power saving mode, or a transmission suppress signal for requesting congestion avoidance of the radio base station being connected to.

According to a fifth aspect of the present invention, a radio base station for communicating with a radio terminal device is provided. The radio base station includes an informing unit for informing of communication conditions with the radio terminal device, and a control unit for instructing the radio terminal device to transmit a transmission suppress signal, when the communication conditions are monitored and deterioration of the communication conditions is detected. In this case, the control unit transmits a transmission suppress signal for switching the radio terminal device into a power saving mode, or a transmission suppress signal for informing of congestion avoidance, when the deterioration of the communication conditions is detected.

According to a sixth aspect of the present invention, a radio access communication method between a plurality of radio base stations and a radio terminal device connectable with the plurality of radio base stations is provided. The present radio access communication method includes the steps of: detecting deterioration of communication conditions between the radio terminal device in a connected state and the radio base stations; and preventing a packet loss by controlling the communication between the radio terminal device in a connected state and the radio base stations and storing packets transmitted and received by the radio terminal device and the radio base stations, when deterioration of the communication conditions is detected.

According to a seventh aspect of the present invention, a radio access communication method between a radio base station and a radio terminal device capable of communicating asynchronously with the radio base station is provided. The present radio access communication method includes the steps of: detecting deterioration of communication conditions in one of the radio terminal device or the radio base station; and transmitting a transmission suppress signal for controlling the communication to the other one of the radio base station or the radio terminal device. In the present radio access communication method, the step of searching for the communication conditions with other radio base stations is executed in the radio terminal device, in connection with transmission and reception of the transmission suppress signal.

According to an eighth aspect of the present invention, a program for a radio terminal device capable of operating in an operation mode of either a normal mode or a communication suppress mode, and connectable with a plurality of radio base stations. The present program includes the steps of: judging which operation mode the radio terminal device is operating in, the normal mode or the communication suppress mode; judging whether communication conditions with a radio base station being connected to have deteriorated, among the plurality of radio base stations; and changing the operation mode to the communication suppress mode when the communication conditions are judged to have deteriorated. In this case, the present program may include the step of searching for radio base stations other than the radio base station being connected to, when changed to the communication suppress mode, or the step of changing the connection to the other radio base stations according to the result of searching.

According to a ninth aspect of the present invention, a program for a radio base station connected to a radio terminal device capable of operating in an operation mode of either a normal mode or a communication suppress mode is provided. The present program includes the steps of: judging the operation mode of the radio terminal device; buffering data for the radio terminal device when the operation mode of the radio terminal device is judged to be the communication suppress mode; and informing the radio terminal device that the data is buffered.

According to a tenth aspect of the present invention, a program for a radio base station connectable with a radio terminal device capable of transmitting a transmission suppress signal is provided. The present program includes the steps of: judging whether the transmission suppress signal from the radio terminal device is received; transmitting a response signal directed to the transmission suppress signal to the radio terminal device, when the transmission suppress signal from the radio terminal device is judged to be received; and switching an operation mode in the radio terminal device to a communication suppress mode.

### BRIEF DESCRIPTION OF THE DRAWINGS

FIG. 1 is a network constitution view for describing first, second and third embodiments of the present invention;

FIG. 2 is a constitution view of a radio base station in a radio access communication system in accordance with the first to third embodiments of the present invention;

FIG. 3 is a flowchart for describing the operation of the radio base station in the radio access communication system in accordance with the first to third embodiments of the present invention;

FIG. 4 is a constitution view of a radio terminal device in the radio access communication system in accordance with the first to third embodiments of the present invention;

FIG. 5 is a flowchart for describing the operation of the radio terminal device in the radio access communication system in accordance with the first to third embodiments of the present invention;

FIG. 6A to FIG. 6E are sequence diagrams for describing the operation of the radio access communication system in accordance with the first embodiment of the present invention;

FIG. 7A to FIG. 7E are sequence diagrams for describing the operation of the radio access communication system in accordance with the second embodiment of the present invention; and

FIG. 8A to FIG. 8E are sequence diagrams for describing the operation of the radio access communication system in accordance with the third embodiment of the present invention.

### DESCRIPTION OF THE PREFERRED EMBODIMENT

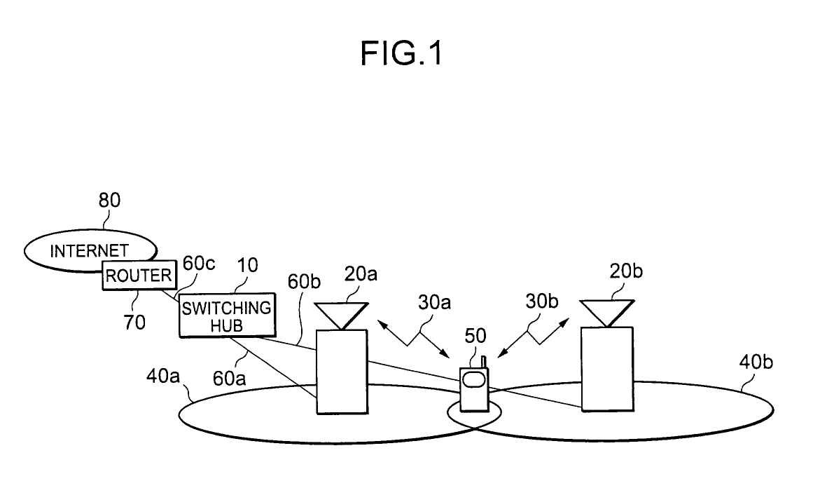

A radio access communication system in accordance with the present invention will be described. The radio access communication system shown in FIG. 1 illustrates a wireless LAN. Here, the operation of the radio access communication system in accordance with the present invention will be schematically described, on the assumption that it supports a power saving mode.

A radio terminal device comprises one transmitter/receiver, and is capable of operating in the power saving mode. When a communication is not made for a certain period, the radio terminal device informs a radio base station of entrance into the power saving mode with a transmission suppress signal, and enters the power saving mode. The radio terminal device in the power saving mode receives only part of beacons transmitted by the radio base station at regular intervals, and for other periods, the transmitter/receiver of the radio terminal device is in a state where a power source is turned OFF. The beacon is controlling data addressed and broadcast from the radio base station to all its subordinate radio terminal devices.

On the other hand, when receiving data addressed to the radio terminal device operating in the power saving mode, the radio base station once retains the received data. The radio base station also transmits information indicating that the radio base station is retaining the data, including the information in a beacon, so as to inform the radio terminal device in the power saving mode. The radio terminal device that has received this information returns to a normal mode, and informs the radio base station that it has returned to the normal mode, and then normal data transmission/reception is started.

The present invention can also be applied to a radio access communication system that supports a congestion avoiding mode. In this case also, about the same operation as that described above is performed. That is, when the radio base station detects the congestion, or receives congestion information (transmission suppress signal) from the radio terminal device, the radio base station once buffers the data addressed to the radio terminal device. Also when detecting a recovery from the congestion or receiving a transmission request from the radio terminal device, the radio base station returns to a normal operation.

Next, concrete constitution of the radio access communication system in accordance with a first embodiment of the present invention will be described with reference to FIG. 1. The radio access communication system includes a router 70, a switching hub 10, radio base stations 20a and 20b, and a radio terminal device 50. The radio base stations 20a and 20b and the router 70 are each connected via the switching hub 10 by Ethernets (registered trademark) 60a, 60b and 60c. The router 70 is connected to an Internet network 80. The radio access communication system to which the present invention is applied may not be connected to the Internet network 80.

The radio base stations 20a and 20b can communicate with the radio terminal device 50 through radio channels 30a and 30b each at different frequencies. It is assumed that the radio base stations and all the radio terminal devices perform channel access to the radio channels by a CSMA/CA (Carrier Sense Multiple Access/Collision Avoidance) method. Also, it is assumed that the radio terminal device 50 exists in an overlapping area of two cells 40a and 40b, and is in a situation to be able to communicate with the radio base stations 20a and 20b.

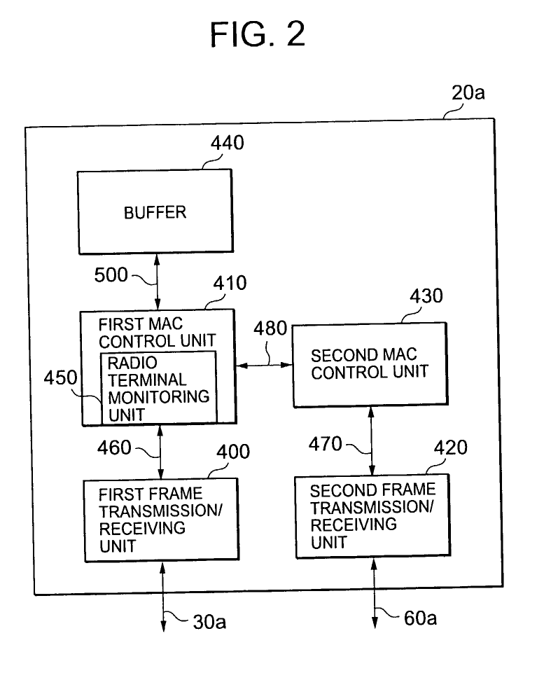

With reference to FIG. 2 to FIG. 5, constitution of the radio terminal device 50 and the radio base station 20a (or 20b) constituting the radio access communication system in accordance with the present invention and their operational sequences will be described in detail.

FIG. 2 shows the constitution of the radio base station 20a, and the radio base station 20b also has similar constitution. The radio base station 20a is constituted of a first frame transmission/receiving unit 400, a first MAC control unit 410, a second frame transmission/receiving unit 420, a second MAC control unit 430, and a buffer 440.

The second frame transmission/receiving unit 420 performs an operation of handing over a frame received from the Ethernet (registered trademark) 60a to the second MAC control unit 430 via a second MAC interface 470. The second frame transmission/receiving unit 420 also performs an operation of transmitting the frame handed over from the second MAC control unit 430 via the second MAC interface 470 to the Ethernet (registered trademark) 60a.

The second MAC control unit 430 hands over a frame that should be transmitted to the radio channel 30a among the frames handed over from the second frame transmission/receiving unit 420, to the first MAC control unit 410 via a bridge interface 480. The second MAC control unit 430 also hands over only the frame that should be transmitted to the Ethernet (registered trademark) 60a among the frames handed over from the first MAC control unit 410 via the bridge interface 480, to the second frame transmission/receiving unit 420.

The first frame transmission/receiving unit 400 hands over a frame received from the radio channel 30a to the first MAC control unit 410 via the first MAC interface 460. The first frame transmission/receiving unit 400 also transmits the frame handed over from the first MAC control unit 410 via the first MAC interface 460 to the radio channel 30a. The first frame transmission/receiving unit 400 further informs of a received power level of the received frame together when handing over the frame to the first MAC control unit 410.

The first MAC control unit 410 has a radio terminal monitoring unit 450 built therein for managing the conditions of the radio terminal device. The first MAC control unit 410 hands over only the frame that should be transmitted to the Ethernet (registered trademark) 60a among the frames handed over from the first frame transmission/receiving unit 400, to the second MAC control unit 430. The first MAC control unit 410 is also handed over a frame from the second MAC control unit 430 via the bridge interface 480.

The frame that should be transmitted to the radio channel 30a is dealt with in the following manner. When an operation mode is the normal mode, the first MAC control unit 410 hands over the frame handed over from the second MAC control unit 430 to the first frame transmission/receiving unit 400 via the first MAC interface 460. On the other hand, when the operation mode is the power saving mode, the first MAC control unit 410 hands over the frame handed over from the second MAC control unit 430 to the buffer 440 via a buffer interface 500.

The first MAC control unit 410 further informs the radio terminal monitoring unit 450 of interruption when the received power level informed by the first frame transmission/receiving unit 400 is a preset threshold value or less, or when a value of a bit/packet error rate based on frame check sequence processing in the first MAC control unit 410 is a prescribed threshold value or less, or when the first MAC control unit 410 receives a transmission suppress signal from the radio terminal device. The radio terminal monitoring unit 450 manages the operation mode (normal mode and power saving mode) of the radio terminal device, and changes the operation mode according to the interruption information from the first MAC control unit 410.

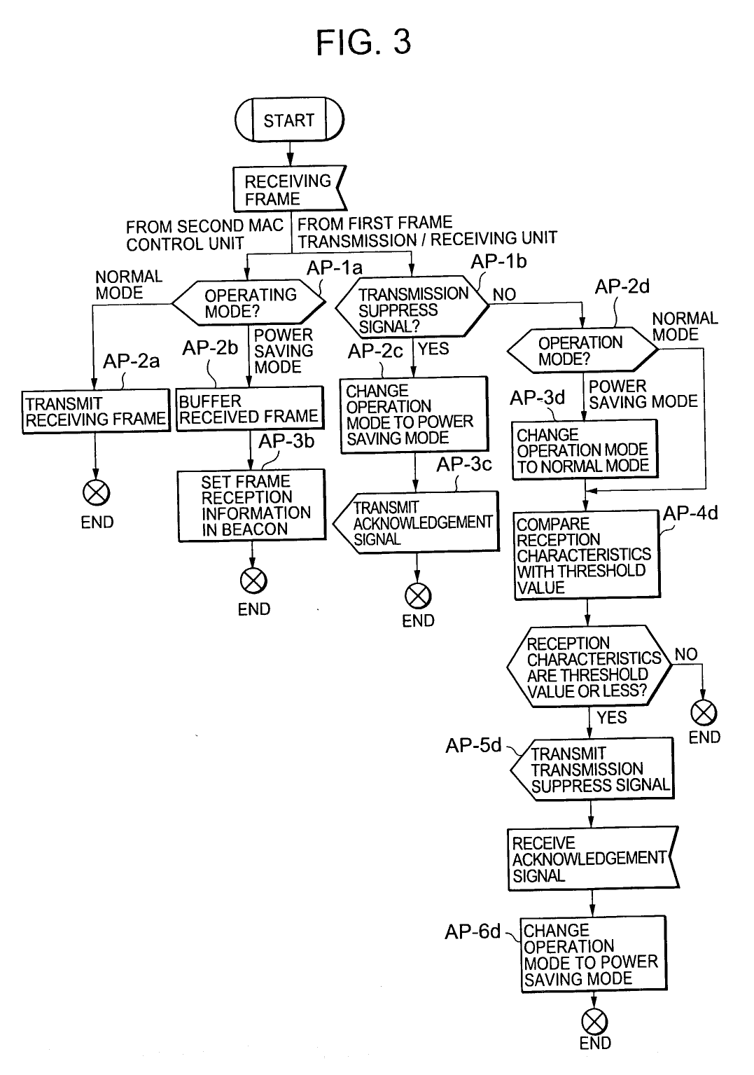

The operation associated with the operation mode of the first MAC control unit 410 and radio terminal monitoring unit 450 is performed in accordance with a program stored in a memory (not shown) that the first MAC control unit 410 comprises. The operation in accordance with this program can be indicated, for example, in a flowchart shown in FIG. 3.

With reference to FIG. 3, in the first MAC control unit 410, first, a frame reception is judged whether it is the frame reception from the first frame transmission/receiving unit 400 or the frame reception from the second MAC control unit 430. As a result of the judgment, in the case of the former, the operation moves to step AP-1b, while in the case of the latter, the operation moves to step AP-1a.

Here, when the frame reception is performed from the Ethernet (registered trademark) 60a via the second frame transmission/receiving unit 420 and the second MAC control unit 430, the first MAC control unit 410 checks the operation mode of the radio terminal device 50 in step AP-1a. When the operation mode is the normal mode as a result of the checking in step AP-1a, the first MAC control unit 410 hands over the received frame to the first frame transmission/receiving unit 400. Then, the first frame transmission/receiving unit 400 transmits the received frame to the radio terminal device 50 (step AP-2a), and the first MAC control unit 410 terminates the processing in accordance with the program.

On the other hand, when the operation mode of the radio terminal device 50 is judged to be the power saving mode in step AP-1a, the received frame received by the first MAC control unit 410 is buffered by the buffer 440 under the control of the program (step AP-2b). Then, the first MAC control unit 410 instructs the first frame transmission/receiving unit 400 on the informing of the frame reception to inform that the first MAC control unit 410 is buffering the frame for the radio terminal device 50. As a result, the frame reception information is set in the beacon output from the first frame transmission/receiving unit 400 (step AP-3b).

When receiving a frame from the first frame transmission/receiving unit 400, the first MAC control unit 410 judges whether or not the received frame is the transmission suppress signal (step AP-1b). When the received frame is judged to be the transmission suppress signal in step AP-1b, the first MAC control unit 410 changes the operation mode to the power saving mode under the control of the program (step AP-2c). The first MAC control unit 410 then creates an acknowledgment signal to hand over to the first frame transmission/receiving unit 400 and terminates the processing in accordance with the program (step AP-3c).

On the other hand, when the frame received from the first frame transmission/receiving unit 400 is judged not to be the transmission suppress signal in step AP-1b, the first MAC control unit 410 checks the operation mode of the radio terminal device 50 (step AP-2d). When the operation mode is judged to be the power saving mode in step AP-2d, step AP-3d follows. In step AP-3d, the first MAC control unit 410 changes the operation mode to the normal mode, and then moves to step AP-4d to compare reception characteristics, for example, the received power level with the preset threshold value. When the received power level is not the preset threshold value or less as a result of the comparison, the first MAC control unit 410 terminates the processing in accordance with the program. On the other hand, when the received power level is the preset threshold value or less, the first MAC control unit 410 instructs the first frame transmission/receiving unit 400 to generate a transmission suppress signal. As a result, the transmission suppress signal is transmitted from the first frame transmission/receiving unit 400 (step AP-5d). Then, when the acknowledgement signal in response to the transmission suppress signal is received from the first frame transmission/receiving unit 400, the operation mode of the first MAC control unit 410 is changed to the power saving mode (step AP-6d).

In addition, when the operation mode is the normal mode as a result of the checking of the operation mode in step AP-2d, step AP-4d follows. In step AP-4d, the above reception characteristics and the threshold value are compared. After that, the same processing as in the case of the power saving mode mentioned above will be performed.

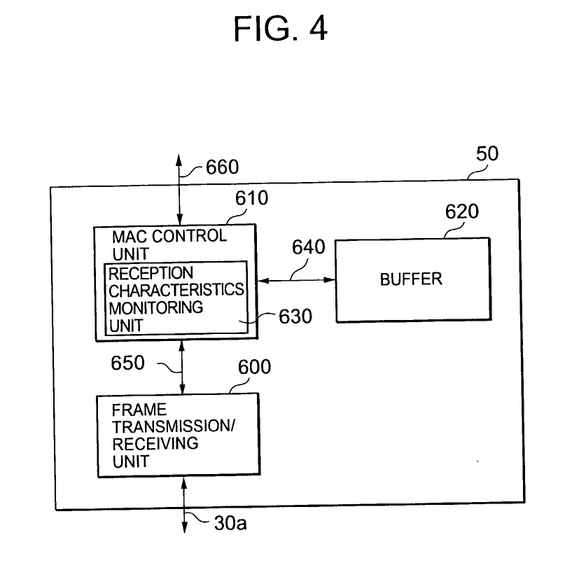

Next, the radio terminal device 50 shown in FIG. 1, for example, comprises the constitution shown in FIG. 4. In FIG. 4, the radio terminal device 50 includes a frame transmission/receiving unit 600, a MAC control unit 610 and a buffer 620. The frame transmission/receiving unit 600 hands over a frame received via the radio channel 30a to the MAC control unit 610 via a MAC interface 650. The frame transmission/receiving unit 600 also transmits the frame handed over from the MAC control unit 610 via the MAC interface 650 to the radio channel 30a. The frame transmission/receiving unit 600 further informs of a received power level together when handing over the received frame to the MAC control unit 610.

The MAC control unit 610 has a reception characteristics monitoring unit 630 and a program memory (not shown) inside, and operates according to a program stored in this program memory. That is, the MAC control unit 610 outputs the frame handed over from the frame transmission/receiving unit 600 via the MAC interface 650 to a software interface 660 according to the program. The MAC control unit 610 also processes the frame received via the software interface 660 according to the program. Concretely, when the operation mode of the radio terminal device 50 is the normal mode, the MAC control unit 610 hands over the received frame to the frame transmission/receiving unit 600 via the MAC interface 650. On the other hand, when the operation mode is the power saving mode, the MAC control unit 610 stores the received frame in the buffer 620 via a buffer interface 640.

The MAC control unit 610 further informs the reception characteristics monitoring unit 630 of interruption when the received power level informed by the frame transmission/receiving unit 600 is the preset threshold value or less, or when a value of a bit/packet error rate based on the frame check sequence processing in the MAC control unit 610 is the prescribed threshold value or less. The reception characteristics monitoring unit 630 manages the operation mode (normal mode and power saving mode) of the radio terminal device according to the program mentioned above, and changes the operation mode according to the interruption information from the MAC control unit 610.

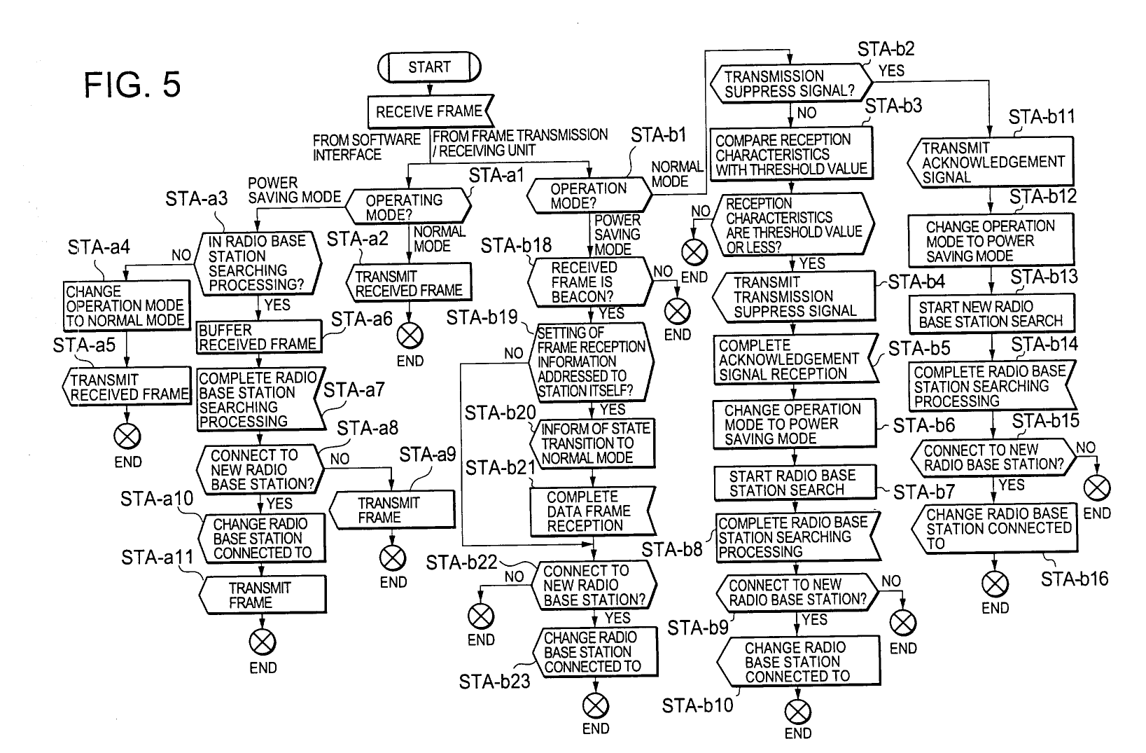

The operation of the MAC control unit 610 and the reception characteristics monitoring unit 630 is performed in accordance with the program. This program can be indicated, for example, in a flowchart shown in FIG. 5.

In FIG. 5, first, a frame reception is judged whether it is the frame reception from the software interface 660 or the frame reception from the frame transmission/receiving unit 600. When it is judged to be the frame reception from the software interface 660, step STA-a1 follows, and the operation mode is checked. When the operation mode is judged to be the normal mode in step STA-a1, the received frame received via the software interface 660 is sent to the frame transmission/receiving unit 600 under the control of the program. The frame transmission/receiving unit 600 transmits the received frame (step STA-a2).

On the other hand, when the operation mode is judged to be the power saving mode in step STA-a1, the processing in accordance with the program will move to step STA-a3. The MAC control unit 610 checks whether the radio terminal device 50 is in searching processing for the radio base station in step STA-a3. If the radio terminal device 50 is in the power saving mode and not in the searching processing for the radio base station, step STA-a4 follows. In step STA-a4, the operation mode is changed to the normal mode, and then the received frame is sent to the frame transmission/receiving unit 600. The frame transmission/receiving unit 600 transmits the received frame (step STA-a5).

On the other hand, when the radio terminal device 50 is judged to be in the searching processing for the radio base station in step STA-a3, the MAC control unit 610 executes step STA-a6, and stores the received frame from the software interface 660 in the buffer 620. After that, when the searching processing for the radio base station in the radio terminal device 50 terminates (step STA-a7), it is judged whether or not to continue the connection with the radio base station 20a being connected to at present, in other words, whether or not to be connected to a new radio base station (step STA-a8). When the connection with the radio base station 20a being connected to at present is continued, the MAC control unit 610 sends the buffered frame to the frame transmission/receiving unit 600. The frame transmission/receiving unit 600 transmits the frame to the radio base station 20a (step STA-a9).

When deciding to be connected to the new radio base station as a result of the searching for the radio base station in step STA-a8, the MAC control unit 610 performs changing processing of the radio base station (step STA-a10), and then sends the frame buffered in the buffer 620 to the frame transmission/receiving unit 600. The frame transmission/receiving unit 600 transmits the frame (step STA-a11).

When it is judged to be the frame reception from the frame transmission/receiving unit 600 at the first frame reception, the operation mode of the radio terminal device 50 is judged whether it is the normal mode or the power saving mode in step STA-b1. When the operation mode is judged to be the normal mode, the operation of the MAC control unit 610 proceeds to step STA-b2. In step STA-b2, the received frame is checked whether or not it is the transmission suppress signal.

When the received frame is not the transmission suppress signal, the MAC control unit 610 compares the reception characteristics, for example, a received power level with the preset threshold value in step STA-b3. When the received power level is not the preset threshold value or less as a result of the comparison, the processing in accordance with the program is terminated. On the other hand, when the received power level is the preset threshold value or less, the MAC control unit 610 sends the transmission suppress signal to the frame transmission/receiving unit 600. The frame transmission/receiving unit 600 transmits the transmission suppress signal (step STA-b4). After this, when finishing the reception of the acknowledgment signal in response to the transmission suppress signal via the frame transmission/receiving unit 600 (step STA-b5), the MAC control unit 610 changes the operation mode to the power saving mode (step STA-b6), and starts the searching processing for the new radio base station (step STA-b7). When finishing the searching processing for the radio base station (step STA-b8), the MAC control unit 610 judges whether or not to be connected to the new radio base station (step STA-b9). When the MAC control unit 610 is not connected to the new radio base station as a result of the judgment, the processing in accordance with the program is terminated. On the other hand, when it is judged to be connected to the new radio base station in step STA-b9, the MAC control unit 610 changes the radio base station to be connected to (step STA-b10), and terminates the processing.

On the other hand, when the frame received from the frame transmission/receiving unit 600 in the normal mode is judged to be the transmission suppress signal in step STA-b2, the MAC control unit 610 instructs the frame transmission/receiving unit 600 to generate an acknowledgment signal. As a result, the acknowledgment signal in response to the transmission suppress signal is transmitted from the frame transmission/receiving unit 600 (step STA-b11). Then, the MAC control unit 610 changes the operation mode of the radio terminal device 50 to the power saving mode (step STA-b12), and starts the searching processing for a new radio base station (step STA-b13). When the searching processing for a new radio base station is terminated in step STA-b14, the MAC control unit 610 judges whether or not to be connected to the new radio base station (step STA-b15). When the MAC control unit 610 decides not to be connected to the new radio base station as a result of the judgment, the processing is terminated. In addition, when it is judged to be connected to the new radio base station in step STA-b15, the radio base station to be connected to is changed under the control of the program in step STA-b16, and the processing is terminated.

Furthermore, when the operation mode of the radio terminal device 50 is judged to be the power saving mode in step STA-b1 mentioned above, the received frame is judged whether or not it is a beacon (step STA-b18). When the received frame is not a beacon as a result of the judgment, the processing is terminated. On the other hand, when the received frame is a beacon, it is judged whether or not frame reception information addressed to the radio terminal device 50 is set in the beacon (step STA-b19). When the frame addressed to the radio base station itself is received by the radio base station, the radio base station is informed of a state transition to the normal mode, in order to receive the frame addressed to the station itself (step STA-b20).

When the data frame is sent from the radio base station in this state and it is detected that the reception of the data frame has been finished (step STA-b21), it is judged whether or not to be connected to the new radio base station (step STA-b22). When it is not necessary to be connected to the new radio base station as a result of the judgment, the processing is terminated. On the other hand, when it is judged to be connected to the new radio base station, a connection change to the radio base station is made (step STA-b23). When the frame addressed to the radio base station itself is not received by the radio base station in step STA-b19, the step STA-b22 follows, and the same step STA-b22 and step STA-b23 as above will be executed.

It is as described above that the aforementioned operation is performed in accordance with the program stored in the program memory of the MAC control unit 610.

It has been described that the operation of the radio base station and the radio terminal device shown in FIG. 3 and FIG. 5 is executed by the software. However, the operation in FIG. 3 and FIG. 5 can also be accomplished by hardware. It is also possible to accomplish in such a manner that the software and hardware share the processing with each other. When the software and hardware share the processing, it is preferable that the processing requiring high speed may be accomplished by the hardware.

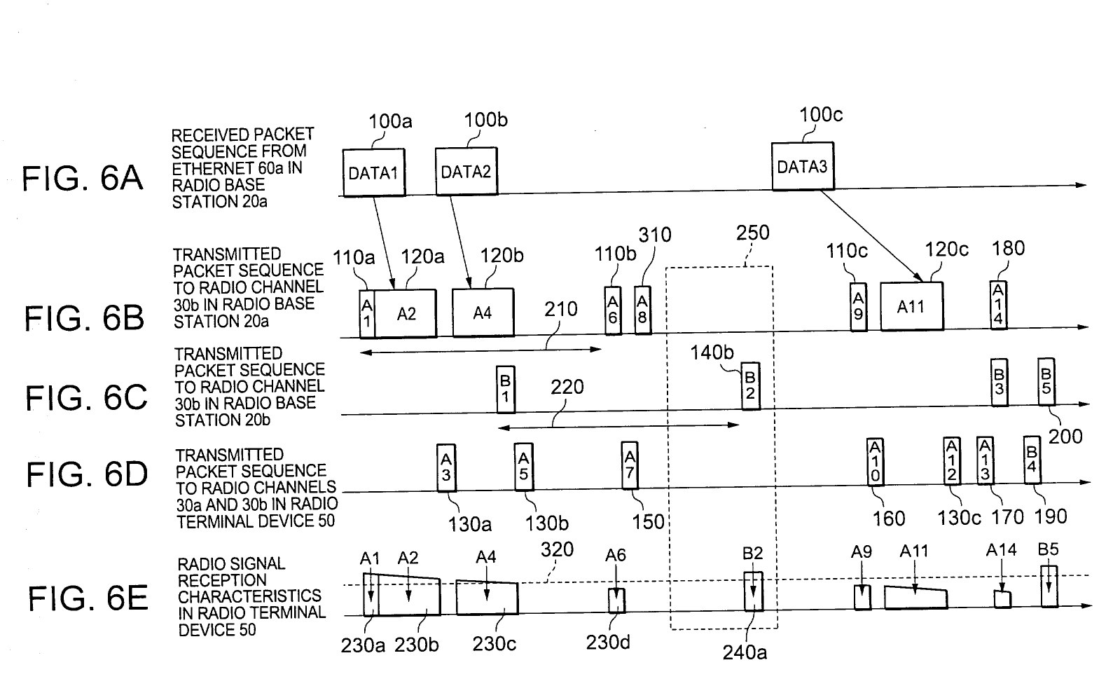

Next, with reference to FIG. 6A to FIG. 6E, an example of operational sequences of the radio base stations 20a and 20b and the radio terminal device 50 will be described in association with each other. The sequences in the first embodiment indicate a case where a radio signal, that is, a received power level of a packet is used as measured reception characteristics.

FIG. 6A shows a received packet sequence from the Ethernet (registered trademark) 60a in the radio base stations 20a, and FIG. 6B shows a transmitted packet sequence to the radio channel 30a in the radio base station 20a. FIG. 6C shows a transmitted packet sequence to the radio channel 30b in the radio base station 20b, and FIG. 6D shows a transmitted packet sequence to the radio channels 30a and 30b in the radio terminal device 50. FIG. 6E shows radio signal reception characteristics in the radio terminal device 50. In FIG. 6A to FIG. 6E, it is shown that time passes from left to right.

In the radio access communication system in the first embodiment, the two radio channels 30a and 30b are assumed as the usable radio channels, as described above.

As indicated by arrows 210 and 220 in lower parts of FIG. 6B to FIG. 6C, the radio base stations 20a and 20b transmit beacons each at definite beacon periods. As apparent from the radio signal reception characteristics in FIG. 6E, the radio terminal device 50 always checks the received power levels of the received packets on the basis of the preset threshold value 320.

In the states shown in FIG. 6A to FIG. 6E, the radio terminal device 50 is first connected to the radio base station 20a. When the radio base station 20a receives data packets 100a and 100b from the Ethernet (registered trademark) 60a as shown in FIG. 6A, the radio base station 20a transmits a beacon 110a as shown in FIG. 6B, and then transfers data packets 120a and 120b via the radio channel 30a.

When receiving the data packets 120a and 120b normally, the radio terminal device 50 transmits each of acknowledgment signals (i.e., normal response signals) 130a and 130b, as shown in FIG. 6D. When receiving the beacons 110a and 110b (see FIG. 6B) as shown in FIG. 6E, the radio terminal device 50 also detects received power levels 230a and 230d of the received beacon, and compares the detected received power levels 230a and 230d with the preset threshold value 320. When the obtained received power level 230d is detected to be the preset threshold value 320 or less as a result of receiving the beacon 110b as shown in FIG. 6E, the radio terminal device 50 transmits a state transition informing packet 150 to the radio base station 20a being connected to, as shown in FIG. 6D.

In this example, the radio terminal device 50 and the radio base station 20a each transit to the power saving mode by the transmission/reception of the state transition informing packet 150, and are in a state of controlling communication. Therefore, the state transition informing packet 150 has a function as the transmission suppress signal.

When receiving the state transition informing packet 150 from the radio terminal device 50, the radio base station 20a transmits a response signal, that is, an acknowledgment signal 310, as shown in FIG. 6B. When receiving the acknowledgment signal 310 from the radio base station 20a, the radio terminal device 50 starts a radio base station search 250, and changes the setting to receive the packet of the radio channel 30b. As a result, the radio terminal device 50 receives a beacon 140b (see FIG. 6C) transmitted by the radio base station 20b.

When detecting that a received power level 240a of the beacon 140b from the radio base station 20b is higher than the preset threshold value 320 as shown in FIG. 6E, the radio terminal device 50 decides to switch the connecting end from the radio base station 20a to the radio base station 20b. Then, the radio terminal device 50 again changes the setting to receive the packet of the radio channel 30b.

On the other hand, when receiving a data packet 100c addressed to the radio terminal device 50 at the time when the radio terminal device 50 is in the power saving mode, the radio base station 20a informs the radio terminal device 50 that the radio base station 20a is retaining a packet addressed to the radio terminal device 50 in a beacon 110c transmitted next. Receiving this information, the radio terminal device 50 returns to the normal mode and transmits a state transition informing packet 160 (see FIG. 6D), and then informs the radio base station 20a that the radio terminal device 50 has returned to the normal mode. The radio terminal device 50 receives a data packet 120c transmitted by the radio base station 20a, and transmits an acknowledgment signal 130c (see FIG. 6D) in response to that. From the fact that the data packet is not transmitted to the radio channel 30a after transmitting the acknowledgment signal 130c, the radio terminal device 50 detects no more data packet to receive, and transmits a connection cancellation requesting packet 170 to the radio base station 20a. When receiving the connection cancellation requesting packet 170, the radio base station 20a transmits an acknowledgment signal 180 to the radio terminal device 50.

When receiving the acknowledgment signal 180 from the radio base station 20a, the radio terminal device 50 again changes the setting to receive the packet of the radio channel 30b, and transmits a connection requesting packet 190 to the radio base station 20b. The radio terminal device 50 receives an acknowledgment signal 200 from the radio base station 20b, and completes connection switching processing.

As described above, in the embodiment shown in FIG. 6A to FIG. 6E, the packet received in the power saving mode is once retained in the radio base station 20a, and then transmitted from the radio base station 20a to the radio terminal device 50 after the cancellation of the power saving mode. In this way, a packet loss can be prevented.

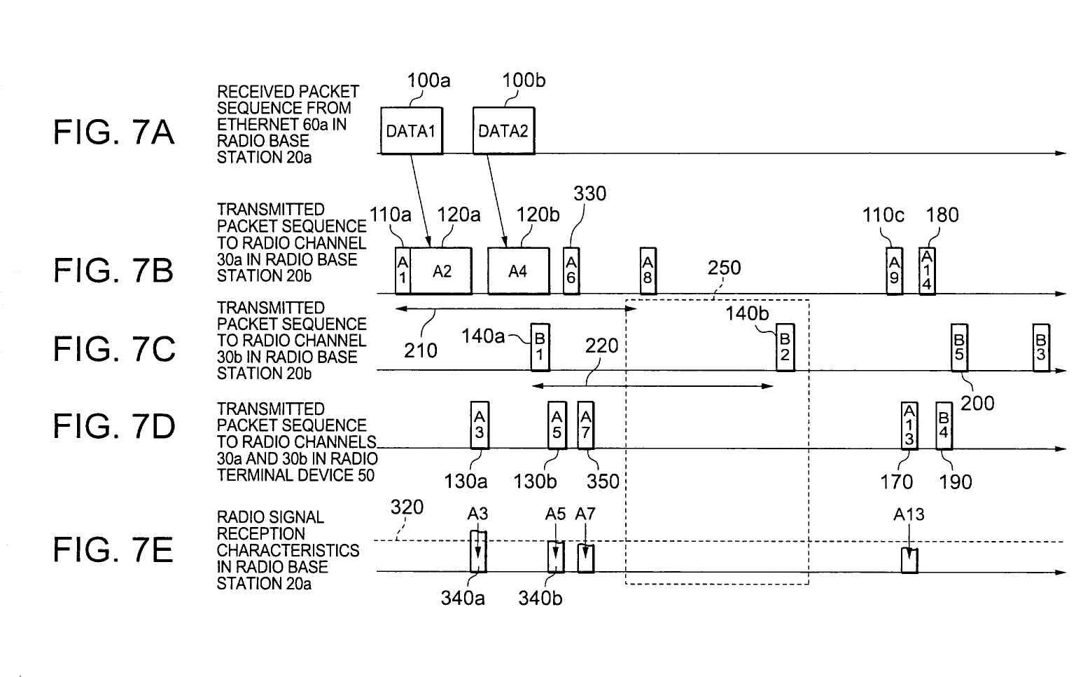

With reference to operational sequence diagrams shown in FIG. 7A to FIG. 7E, the radio access communication system in accordance with a second embodiment of the present invention will be described.

FIG. 7A to FIG. 7E show the operational sequences of the radio terminal device 50, the radio base stations 20a and 20b in the radio access communication system in accordance with the second embodiment of the present invention. Similarly to FIG. 6A to FIG. 6D, FIG. 7A shows a received packet sequence of the radio base stations 20a, and FIG. 7B shows a transmitted packet sequence to the radio channel 30a in the radio base station 20a. FIG. 7C shows a transmitted packet sequence to the radio channel 30b in the radio base station 20b, and FIG. 7D shows a transmitted packet sequence to the radio channels 30a and 30b in the radio terminal device 50. In addition, FIG. 7E shows radio signal reception characteristics in the radio base stations 20a.

In FIG. 7A to FIG. 7E also, time passes from left to right, similarly to FIG. 6A to FIG. 6E. Furthermore, also in the radio access communication system in accordance with the second embodiment, the two radio channels 30a and 30b are assumed as the usable radio channels. The radio base stations 20a and 20b transmit beacons each at definite beacon periods 210 and 220. It will be assumed that the radio base station 20a always checks the received power levels of the packets received from the radio terminal device 50.

First, it is assumed that the radio terminal device 50 is connected to the radio base station 20a, and that the data packets 100a and 100b to the radio terminal device 50 have been given to the radio base station 20a from the Ethernet (registered trademark) 60a. In this case, when receiving the data packets 100a and 100b, the radio base station 20a transmits the beacon 110a, and then transfers the data packets 120a and 120b to the radio channel 30a (see FIG. 7B). When receiving the data packets 120a and 120b normally, the radio terminal device 50 transmits the acknowledgment signals 130a and 130b as response signals, as shown in FIG. 7D.

In this example, as shown in FIG. 7E, received power levels 340a and 340b of the acknowledgment signals 130a and 130b received in the radio base station 20a are compared with the preset threshold value 320. In this example, when the received power level 340b of the acknowledgment signal 130b is detected to be the preset threshold value 320 or less, the radio base station 20a transmits a state transition informing packet 330, as shown in FIG. 7B. In this example, the state transition informing packet 330 informs of a transition to the state of the power saving mode. As a result, the state transition informing packet 330 functions as the transmission suppress signal.

When receiving the state transition informing packet 330, in response to this, the radio terminal device 50 changes the setting to receive the packet of the radio channel 30b. In this way, the radio terminal device 50 can receive the beacon 140b transmitted by the radio base station 20b, and detects the presence of the radio base station 20b.

Similarly to the case of FIG. 6A to FIG. 6E, the radio terminal device 50 detects that the received power level of the beacon 140b is the preset threshold value 320 or more, and decides to switch the connecting end from the radio base station 20a to the radio base station 20b. After this decision, the radio terminal device 50 again changes the setting to receive the packet of the radio channel 30a. In this state, the radio terminal device 50 receives the beacon 110c (see FIG. 7C) transmitted by the radio base station 20a. When detecting that the radio base station 20a is not retaining the packet addressed to the radio terminal device 50 from the beacon 110c received from the radio base station 20a, the radio terminal device 50 transmits the connection cancellation requesting packet 170 (see FIG. 7D).

When receiving the acknowledgment signal 180, which is a response to the connection cancellation requesting packet 170, from the radio base station 20a, the radio terminal device 50 again transmits the connection requesting packet 190 of the radio channel 30b. When receiving the acknowledgment signal 200 from the radio base station 20b, the radio terminal device 50 completes the connection switching processing.

As described above, in the second embodiment, the radio base station monitors the received power level of the acknowledgment signal from the radio terminal device 50, and the radio terminal device 50 is put in a communication controlled state, in this example, the power saving mode when the received power level becomes the preset threshold value or less, thereby preventing a packet loss.

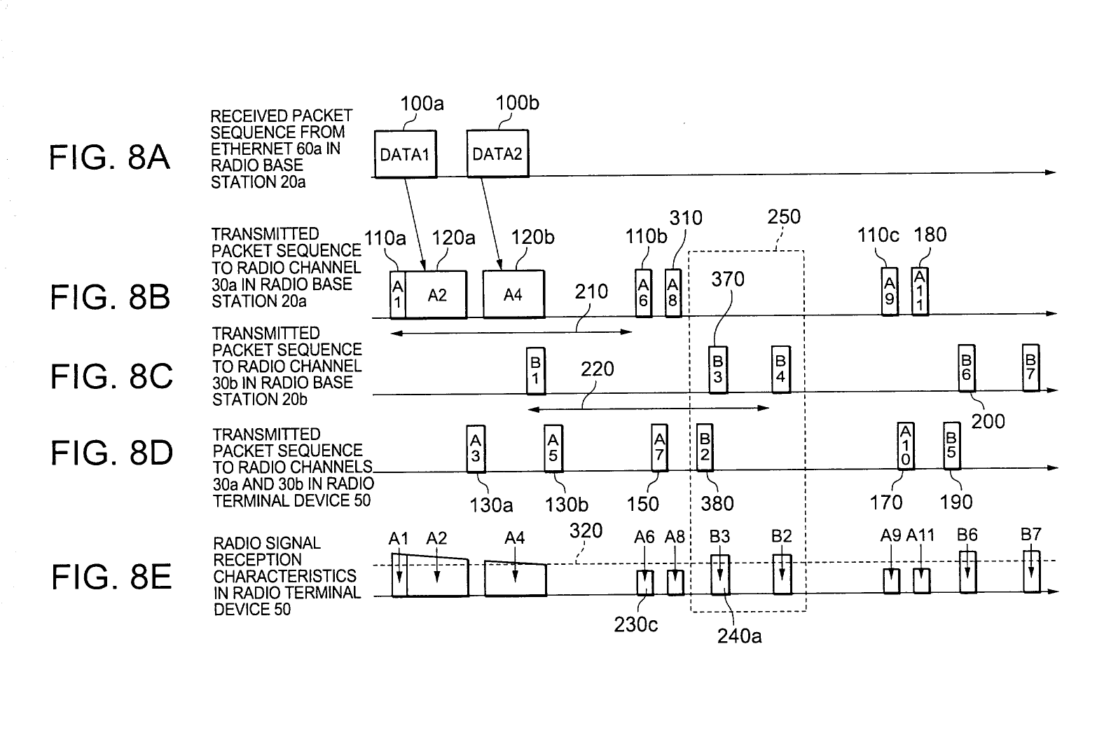

With reference to FIG. 8A to FIG. 8E showing the operational sequences of the radio base stations 20a and 20b, the radio access communication system in accordance with a third embodiment of the present invention will be described. FIG. 8A shows a received packet sequence from the Ethernet (registered trademark) 60a in the radio base stations 20a, and FIG. 8B shows a transmitted packet sequence to the radio channel 30a in the radio base station 20a. FIG. 8C shows a transmitted packet sequence to the radio channel 30b in the radio base station 20b, and FIG. 8D shows a transmitted packet sequence to the radio channels 30a and 30b in the radio terminal device 50. FIG. 8E shows the radio signal reception characteristics in the radio terminal device 50, similarly to FIG. 6E.

In FIG. 8A to FIG. 8E also, time passes from left to right. Also in this example, the two radio channels 30a and 30b are assumed as the usable radio channels. As shown in FIG. 8B and FIG. 8C, the radio base stations 20a and 20b transmit beacons each at the definite beacon periods 210 and 220. The radio terminal device 50 always checks the received power levels of the received packets on the basis of the preset threshold value 320.

First, the radio terminal device 50 is connected to the radio base station 20a. When receiving the data packets 100a and 100b from the Ethernet (registered trademark) 60a, the radio terminal device 50 transfers the data packets 120a and 120b to the radio channel 30a after transmitting the beacon 110a. The radio terminal device 50 receives the data packets 120a and 120b normally, and transmits the acknowledgment signals 130a and 130b.

When detecting that the obtained received power level 230c is the preset threshold value 320 or less as a result of receiving the beacon 110b as shown in FIG. 8E, the radio terminal device 50 transmits the state transition informing packet 150 (see FIG. 8D), and informs the radio base station 20a of a transition to the state of the power saving mode. As a response to this, the radio base station 20a transmits the acknowledgment signal 310. The radio terminal device 50, which has received the acknowledgment signal 310, starts the radio base station search 250, and changes the setting to be able to receive the packet of the radio channel 30b. The radio terminal device 50 transmits a beacon requesting packet (control information requesting signal) 380 to the radio channel 30b (see FIG. 8D). Receiving this, the radio base station 20b transmits a beacon 370 (see FIG. 8C).

When detecting that the received power level 240a of the received beacon 370 is higher than the preset threshold value 320, the radio terminal device 50 decides to switch the connecting end from the radio base station 20a to the radio base station 20b. Then, the radio terminal device 50 again changes the setting to receive the packet of the radio channel 30a. When receiving the beacon 110c transmitted by the radio base station 20a and detecting that the radio base station 20a is not retaining the packet addressed to the radio terminal device 50, the radio terminal device 50 transmits the connection cancellation requesting packet 170 (see FIG. 8D).

In addition, when receiving the acknowledgment signal 180 from the radio base station 20a, the radio terminal device 50 again changes the setting to be able to receive the packet of the radio channel 30b, and transmits the connection requesting packet 190 to the radio base station 20b. Further, when receiving the acknowledgment signal 200 from the radio base station 20b, the radio terminal device 50 completes the connection switching processing.

The third embodiment described above is different from the first and second embodiments in that the radio terminal device actively transmits the beacon requesting packet 380 to the neighboring radio base stations when the radio terminal device is in the communication controlled state such as the power saving mode.

As above, the present invention has been described in connection with the three embodiments, and in any of the embodiments, the radio terminal device can prevent the packet loss due to the handover simply by providing a single transmission/receiving device.

It is needless to say that the present invention is not limited to the first to third embodiments, and that various modifications may be aimed within the scope of the present invention. For example, although the power saving mode function for controlling the packet transmission to the radio terminal device is used in the first to third embodiments, it is also possible to use the aforementioned congestion avoiding function for controlling the packet transmission to the radio terminal device. The radio base station and the radio terminal device perform channel access to the same radio channel using the multiaccess control method, however, it is possible to apply the radio channels at different frequencies to an up channel and a down channel.

The case of switching the two radio base stations has been described as an example of switching the connection of the radio terminal device, however, it is also possible to selectively switch three radio base stations or more. The radio terminal device judges a new connection end from the result of the radio base station search, however, it is also possible to inform the radio base station of the result of the radio base station search and leave the judgment to the radio base station.

The received power level is used as a judgmental standard of the reception characteristics, however, it is also possible to apply the bit error rate and packet error rate. In the first to third embodiments, the connection switching processing with the radio base station in the radio terminal device takes a procedure of starting a connection with a new radio base station after canceling the connection with the radio base station being connected to. However, the present invention can also apply a procedure of starting the connection immediately after detecting a new radio base station, and informing the new radio base station of entrance into the power saving mode, before canceling the connection with the former radio base station.

In the first to third embodiments, when changing the connection to a new radio base station, the radio terminal device once again switches the connection to the radio base station being connected to after detecting the new radio base station, in order to receive data buffered by the radio base station being connected to. However, it is also possible not to switch the connection to the radio base station being connected to, and perform connection processing with the new radio base station immediately after detecting the new radio base station, and further make the data, which is buffered by the radio base station formerly connected to, transferred to the new radio base station.

The effects of the present invention is that, in the radio access communication system performing the packet transmission asynchronously, the radio terminal device equipped with only one transmitter/receiver can search for the neighboring radio base stations using different frequencies, without causing a packet loss even while receiving data from the radio base station. This is because the radio terminal device transmits the transmission suppress signal representing the power saving mode or the like to the radio base station, and temporarily stops the transmission of packets addressed to the radio terminal device, and then searches for the neighboring radio base stations.

What is claimed is:

1. A radio access communication system including a plurality of radio base stations and a radio terminal device connectable with said plurality of radio base stations, wherein
said radio terminal device includes judgment means for judging whether communication conditions have deteriorated; and
when connected to a first radio base station included in said plurality of radio base stations, said radio terminal device transmits a transmission suppress signal for suppressing a communication with said radio terminal device to said first radio base station if the communication conditions with said first radio base station deteriorate, and said radio terminal device searches for the communication conditions with other radio base stations.

2. The radio access communication system according to claim 1, wherein when the communication conditions with said first radio base station deteriorates, said radio terminal device, which is connected to said first radio base station, transmits a signal for informing said first radio base station that said radio terminal device enters a power saving mode, as said transmission suppress signal, and said radio terminal device searches for the communication conditions with other radio base stations.

3. The radio access communication system according to claim 1, wherein when the communication conditions with said first radio base station deteriorate, said radio terminal device, which is connected to said first radio base station, transmits a signal by which said radio terminal device requests congestion avoidance of said first radio base station, as said transmission suppress signal, and said radio terminal device searches for the communication conditions with other radio base stations.

4. The radio access communication system according to claim 1, wherein said judgment means judges the deterioration of the communication conditions by a detection result of a received power level.

5. The radio access communication system according to claim 1, wherein said judgment means judges the deterioration of the communication conditions by a bit error rate.

6. The radio access communication system according to claim 1, wherein said judgment means judges the deterioration of the communication conditions by a frame error rate.

7. The radio access communication system according to claim 1, wherein said radio terminal device changes the connection from said first radio base station to the other radio base station, according to a result of searching for the communication conditions with said other radio base stations.

8. A radio access communication system including a plurality of radio base stations and a radio terminal device connectable with said plurality of radio base stations, wherein
each of said radio base stations includes judgment means for judging whether communication conditions have deteriorated; and
a first radio base station, which is included in said plurality of radio base stations and connected to said radio terminal device, controls a communication with said radio terminal device if the communication conditions with said radio terminal device deteriorate, and transmits a transmission suppress signal to said radio terminal device, and lets said radio terminal device search for the communication conditions with other radio base stations.

9. The radio access communication system according to claim 8, wherein when the communication conditions with said radio terminal device deteriorate, said first radio base station controls the communication with said radio terminal device, and transmits a transmission suppress signal for letting said radio terminal device enter a power saving mode to said radio terminal device, and lets said radio terminal device search for the communication conditions with other radio base stations.

10. The radio access communication system according to claim 8, wherein when the communication conditions with said radio terminal device deteriorate, said first radio base station controls the communication with said radio terminal device, and transmits a transmission suppress signal for informing said radio terminal device of congestion avoidance, and lets said radio terminal device search for the communication conditions with other radio base stations.

11. The radio access communication system according to claim 8, wherein said judgment means judges the deterioration of said communication conditions by a detection result of a received power level.

12. The radio access communication system according to claim 8, wherein said judgment means judges the deterioration of said communication conditions by a bit error rate.

13. The radio access communication system according to claim 8, wherein said judgment means judges the deterioration of said communication conditions by a frame error rate.

14. The radio access communication system according to claim 8, wherein said radio terminal device changes the connection from said first radio base station to the other radio base station, according to a result of searching for the communication conditions with said other radio base stations.

15. A radio access communication system including a plurality of radio base stations and a radio terminal device connectable with said plurality of radio base stations, wherein
said radio terminal device includes judgment means for judging whether communication conditions have deteriorated;
when connected to a first radio base station included in said plurality of radio base stations, said radio terminal device transmits a transmission suppress signal for suppressing a communication with said radio terminal device to said first radio base station if the communication conditions with said first radio base station deteriorate, and said radio terminal device searches for the communication conditions with other radio base stations; and
said radio terminal device transmits a control information requesting signal to detect whether a radio base station exists, when searching for the communication conditions with said other radio base stations.

16. The radio access communication system according to claim 15, wherein when the communication conditions with said first radio base station deteriorate, said radio terminal device, which is connected to said first radio base station, transmits a signal for informing said first radio base station that said radio terminal device enters a power saving mode, as said transmission suppress signal, and said radio terminal device searches for the communication conditions with other radio base stations.

17. The radio access communication system according to claim 15, wherein when the communication conditions with said first radio base station deteriorate, said radio terminal device, which is connected to said first radio base station, transmits a signal by which said radio terminal device requests congestion avoidance of said first radio base station, as said transmission suppress signal, and searches for the communication conditions with other radio base stations.

18. The radio access communication system according to claim 15, wherein said judgment means judges the deterioration of the communication conditions by a detection result of a received power level.

19. The radio access communication system according to claim 15, wherein said judgment means judges the deterioration of said communication conditions by a bit error rate.

20. The radio access communication system according to claim 15, wherein said judgment means judges the deterioration of said communication conditions by a frame error rate.

21. The radio access communication system according to claim 15, wherein said radio terminal device changes the connection from said first radio base station to the other radio base station, according to a result of searching for the communication conditions with said other radio base stations.

22. A radio terminal device connectable with a plurality of radio base stations, wherein
said radio terminal device can operate in an operation mode of either a normal mode or a communication suppress mode; and
said radio terminal device includes informing means for informing of communication conditions with a radio base station being connected to among said plurality of radio base stations, and control means for changing said operation mode to said communication suppress mode when detecting deterioration of said informed communication conditions.

23. The radio terminal device according to claim 22, comprising means for checking whether or not radio base stations other than said radio base station being connected to are searched for, when said operation mode is said communication suppress mode.

24. The radio terminal device according to claim 22, having a buffer for storing a transmission signal to said radio base station being connected to, when said operation mode is said communication suppress mode.

25. The radio terminal device according to claim 22, wherein said communication controlled mode is at least one of a power saving mode or a congestion avoiding mode.

26. The radio terminal device according to claim 22, wherein said control means measures reception characteristics in the communication with said radio base station being connected to, so as to detect the deterioration of said communication conditions.

27. The radio terminal device according to claim 26, wherein said reception characteristics are any of a received power level, bit error rate or packet error rate from said radio base station being connected to.

28. The radio terminal device according to claim 22, wherein said control means includes means for generating a transmission suppress signal which informs of entrance into said communication suppress mode when the deterioration of said communication conditions is detected.

29. The radio terminal device according to claim 22, wherein said control means detects the deterioration of said communication conditions by making a comparison using a preset threshold value.

30. The radio terminal device according to claim 22, wherein said control means changes the connection from said first radio base station to the other radio base station according to the result of searching for said other radio base stations.

31. A radio base station for communicating with a radio terminal device, including informing means for informing of communication conditions with said radio terminal device, and control means for instructing said radio terminal device to transmit a transmission suppress signal, when said communication conditions are monitored and deterioration of the communication conditions is detected.

32. The radio base station according to claim 31, wherein said control means transmits a transmission suppress signal for switching said radio terminal device into a power saving mode when the deterioration of said communication conditions is detected.

33. The radio base station according to claim 31, wherein said control means transmits a transmission suppress signal for informing said radio terminal device of congestion avoidance when the deterioration of said communication conditions is detected.

34. The radio base station according to claim 31, wherein said control means detects the deterioration of said communication conditions by monitoring at least one of a received power level, bit error rate or frame error rate.

35. A radio base station connectable with a radio terminal device capable of transmitting a transmission suppress signal, said radio base station including:
receiving means for receiving said transmission suppress signal from said radio terminal device; and control means for transmitting a response signal directed to said transmission suppress signal to said radio terminal device and switching an operation mode for said radio terminal device to a communication suppress mode, when detecting said transmission suppress signal.

36. The radio base station according to claim 35, including a buffer for storing a transmission packet for said radio terminal device when detecting said transmission suppress signal in said control means.

37. A radio access communication method between a plurality of radio base stations and a radio terminal device connectable with the plurality of radio base stations, said radio access communication method including the steps of:
detecting deterioration of communication conditions between said radio terminal device in a connected state and said radio base stations; and
suppressing the communication between said radio terminal device in a connected state and said radio base stations, and storing packets transmitted and received by said radio terminal device and said radio base stations, when deterioration of said communication conditions is detected.

38. The radio access communication method according to claim 37, wherein the detection of the deterioration of said communication conditions is performed by either said radio terminal device or said radio base stations.

39. A radio access communication method between a radio base station and a radio terminal device capable of communicating asynchronously with said radio base station, said radio access communication method including the steps of:
detecting deterioration of communication conditions in one of said radio terminal device or said radio base station; and
transmitting a transmission suppress signal for suppressing the communication to the other one of said radio base station or said radio terminal device; and wherein
the step of searching for the communication conditions with other radio base station is executed in said radio terminal device, in connection with transmission and reception of said transmission suppress signal.

40. The radio access communication method according to claim 39, further including the step of storing a packet which has received a transmission request after the deterioration of the communication conditions, when said transmission suppress signal is received, in said radio terminal device or said radio base station which has detected the deterioration of the communication conditions.

41. The radio access communication method according to claim 39, wherein said transmission suppress signal instructs to switch to at least one of a power saving mode or a congestion avoiding mode.

42. The radio access communication method according to claim 39, wherein said radio terminal device executes the step of changing the connection from said first radio base station to other radio base station according to the result of searching for communication conditions with other radio base stations.

43. A program for a radio terminal device capable of operating in an operation mode of either a normal mode or a communication suppress mode, and connectable with a plurality of radio base stations, said program includes the steps of:
judging which operation mode said radio terminal device is operating in, said normal mode or said communication suppress mode;
judging whether communication conditions with a radio base station being connected to have deteriorated, among said plurality of radio base stations; and
changing said operation mode to said communication suppress mode when said communication conditions are judged to have deteriorated.

44. The program for a radio terminal device according to claim 43, including the step of searching for radio base stations other than said radio base station being connected to, when changed to said communication suppress mode.

45. The program for a radio terminal device according to claim 44, further including the step of changing the connection to said other radio base stations according to the result of searching.

46. A program for a radio base station connected to a radio terminal device capable of operating in an operation mode of either a normal mode or a communication suppress mode, said program including the steps of:
judging the operation mode of said radio terminal device;
buffering data for said radio terminal device when the operation mode of said radio terminal device is judged to be said communication suppress mode; and
informing said radio terminal device that the data is buffered.

47. A program for a radio base station connectable with a radio terminal device capable of transmitting a transmission suppress signal, said program including the steps of:
judging whether the transmission suppress signal from said radio terminal device is received;
transmitting a response signal directed to said transmission suppress signal to said radio terminal device, when the transmission suppress signal from said radio terminal device is judged to be received; and
switching an operation mode in said radio terminal device to a communication suppress mode.
